(19) United States
(12) Patent Application Publication
(10) Pub. No.: US 2010/0257670 A1
(43) Pub. Date: Oct. 14, 2010

(54) SHOWER HEAD FOR THE SELECTIVE OPERATION IN AT LEAST TWO OPERATING MODES

(75) Inventors: Benjamin Hodel, Jona (CH); Paul Paul Bösch, Lichtensteig (CH)

Correspondence Address: SUGHRUE MION, PLLC, 2100 PENNSYLVANIA AVENUE, N.W., SUITE 800, WASHINGTON, DC, 20037, US

(73) Assignee: WEIDMANN PLASTICS TECHNOLOGY AG, Rapperswil (CH)

(21) Appl. No.: 12/744,443

(22) PCT Filed: Nov. 6, 2008
(86) PCT No.: PCT/CH08/00467

§ 371 Date: May 24, 2010

(30) Foreign Application Priority Data
Nov. 27, 2007 (CH) 01835/07

(51) Int. Cl. B05B 1/18

(52) U.S. Cl. 4/596

(57) ABSTRACT

The shower head comprises a housing (2) and a valve (V) disposed therein, said valve having a valve body (14) that is disposed in a water channel (33). The valve body is connected to an actuating body (3) and interacts with at least one valve seat (24, 25) for closing and/or opening or switching the water channel (33). A pulsator wheel (38) can be connected to the water channel (33) and is detachably locked to a switching body (40) that is operatively connected to the actuating body (3). The actuating body (3) is supported on the housing (2) rotatably about a longitudinal axis (45) of the valve body (14) and thus connected to the switching body (40) such that it can be adjusted with a rotational movement of the actuating body (3) about the longitudinal axis (45) in order to lock or release the pulsator wheel (38).

The invention relates to a shower head for selective operation in at least two operating modes, comprising a housing and a valve disposed therein, said valve having a valve member disposed in a water channel, which valve member is connected to an actuating member and, for opening and closing or switching of the water channel, interacts with at least one valve seat, and comprising a pulsator wheel, which can be connected to the water channel and can be detachably locked with a switching member operatively connected to the actuating member.

A shower head of this type has been disclosed in the prior art by EP-A-0 732 148. In this shower head, an operating mode is possible in which a shower jet is periodically interrupted. For the interruption of the shower jet, a pulsator wheel is provided, which is rotatably mounted in an annular space. The pulsator wheel is equipped with a multiplicity of a type of turbine blades. The pulsator wheel can be rotated by an appropriate inflow of water, so that it periodically interrupts the shower jet. The pulsator wheel can be locked with a switching member. This switching member is of rod-shaped configuration and is disposed coaxially within a valve body of hollow configuration. The switching member is operatively connected to a rocker, which simultaneously forms the actuating member. The switching member can be displaced within the valve body, and the pulsator wheel thus fixed and released, by swiveling of the rocker.

A shower head comprising a lockable pulsator wheel has additionally been disclosed by U.S. Pat. No. 4,010,899. For locking, a push button disposed on the side of the housing is provided. If this is displaced inward, then the pulsator wheel is locked. In order to release the latter, this push button must be moved outward.

The object of the invention is to provide a shower head of said type, which allows a still simpler operation and yet is easier to produce in design terms.

The object is achieved according to claim 1 by virtue of the fact that the actuating member is mounted, for instance on the housing, valve housing or on an insert, rotatably about a longitudinal axis of the valve member and is connected to the switching member such that the latter is adjustable with a rotary movement of the actuating member about said longitudinal axis in order to lock or release the pulsator wheel mounted in a water chamber and, in particular, an annular channel, which water chamber or annular channel is connectable to the water channel. In the shower head according to the invention, the pulsator wheel can be energized or locked with a rotary movement of the actuating member about the longitudinal axis of the valve member. This allows, in particular, the actuating member to be produced as a push button which is rotatable about the longitudinal axis of the valve member. This enables, on the one hand, a simple one-handed actuation and, on the other hand, a substantially simpler structure in design terms. In particular, the valve can be closed and opened by a movement of the push button in the longitudinal direction of the valve member. The valve is, in particular, a switching valve. In principle, the valve can also, however, be a shut-off valve. The shower head according to the invention is preferably configured such that it can be actuated and switched by pressing and turning of the actuating member.

According to a refinement of the invention, it is provided that a rotary movement of the actuating member for locking of the pulsator wheel is opposite to a rotary movement for releasing the locking of the pulsator wheel. In one rotational direction, the pulsator wheel is thus energized, and in another rotational direction it is locked. This allows a particularly simple operation of the shower head according to the invention.

According to a refinement of the invention, it is provided that the switching member is arranged at a distance from and parallel to the closure member. This allows an independent mounting of the valve body and of the closure member and allows a simple and particularly functionally reliable design. It is here provided, in particular, that the switching member has a pin, which in a locking state engages with a lower end in the pulsator wheel. An actuation of the switching member is particularly simple and functionally reliable when said pin engages with an upper end in the actuating member and is controlled at the latter. In particular, it is provided that the switching member, by turning of the actuating member, can be raised counter to the reactive force of a spring in order to release the pulsator wheel.

According to a refinement of the invention, it is provided that the actuating member can be locked by displacement of the actuating member along the longitudinal axis of the valve body, as well as by a rotary movement of the actuating member about the longitudinal axis of the valve body. By displacement of the actuating member and a subsequent rotary movement, the shower head according to the invention can be switched into a second operating mode and, in this, the pulsator wheel energized.

According to a refinement of the invention, the actuating member is, in particular, a push button, which is disposed on a side of the shower head which lies opposite an outlet. This allows the shower head to be made in a particularly compact, cylindrical form.

The valve is, in particular, a switching valve, which allows switching between two types of jet. In a first operating mode, the jet type is, for instance, a centrally arranged perlator. In the other operating mode, the water makes its way out through peripherally arranged nozzle apertures. Preferably, in this second operating mode, the pulsator wheel can be energized, whereby a third operating mode is possible. The valve can also in principle, however, be a shut-off valve, which in a first position of the valve body closes off the water channel and in a second position no longer closes this off. In the second position, the pulsator wheel can then be energized.

Preferably, movements to lock the actuating member and to release the locking of the pulsator wheel are oppositely directed. Preferably, the rotary movement of the actuating member to release said pulsator wheel is opposite to the rotary movement to lock it.

Preferably, the actuating member possesses a preferably middle basic position, in which the actuating member is displaceable in the longitudinal direction of the valve member. Preferably, the water makes its way out through a perlator in the end position and out through nozzle apertures in the operating position, in which operating position the pulsator wheel can be energized.

Further advantageous features emerge from the dependent patent claims, the following description and the drawing.

An illustrative embodiment of the invention is explained in greater detail below with reference to the drawing, in which:

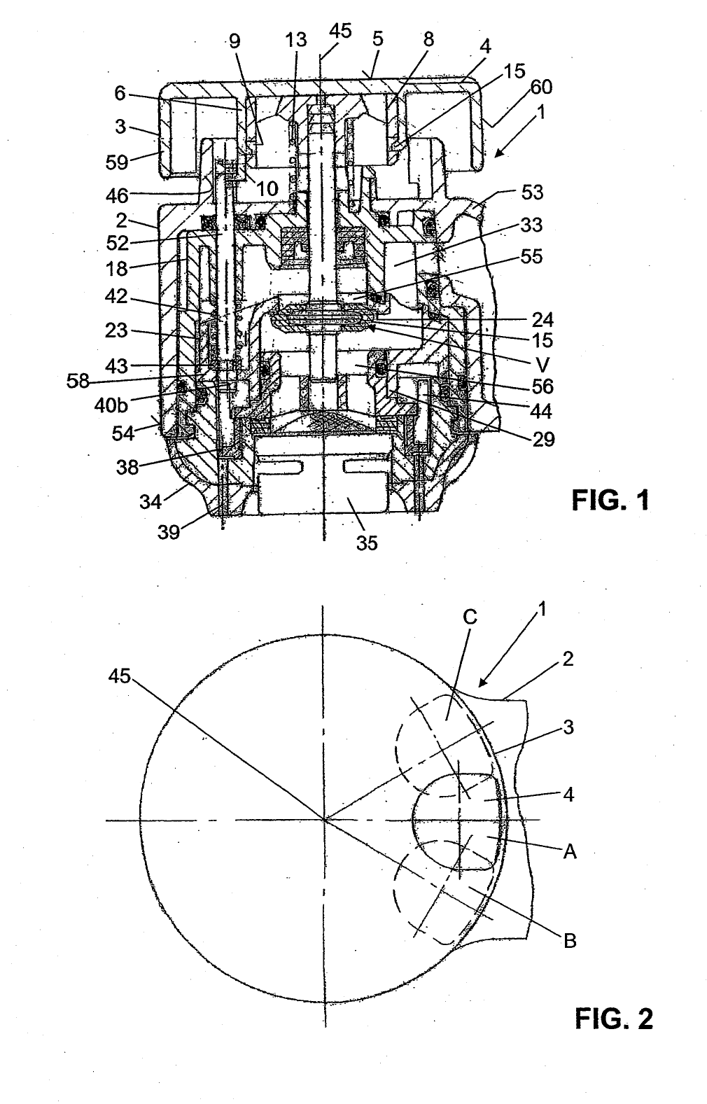

FIG. 1 shows a section through a shower head according to the invention, the grip having been truncated,

FIG. 2 shows a top view of the shower head according to FIG. 1,

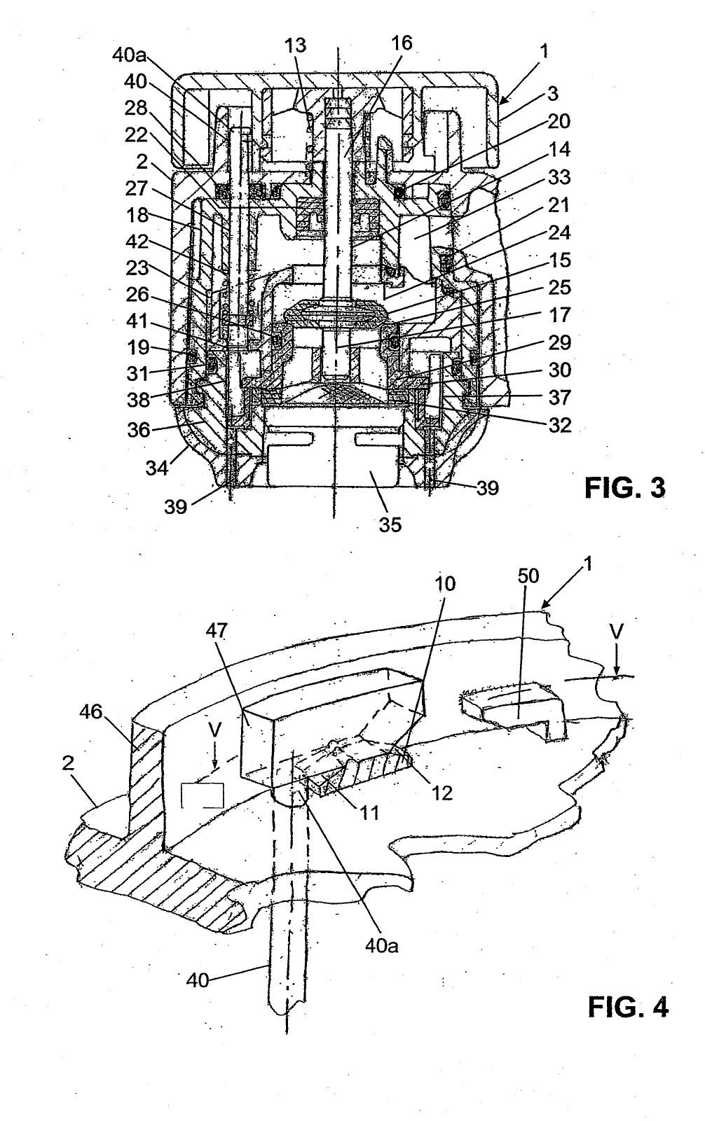

FIG. 3 shows a further section through the shower head, wherein the pulsator wheel is energized,

FIG. 4 shows in schematic representation a three-dimensional partial view of the shower head according to the invention,

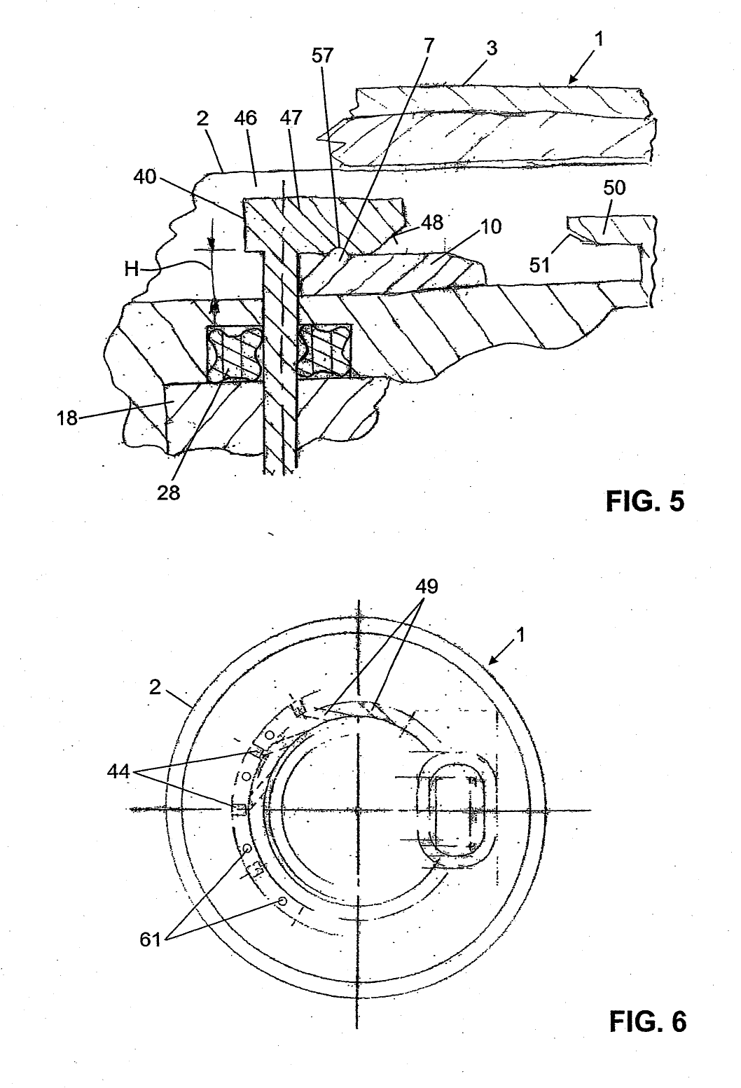

FIG. 5 shows a section along the line V-V of FIG. 4,

FIG. 6 shows in schematic representation a partial view of the pulsator wheel and of the guide surfaces for the driving of the pulsator wheel,

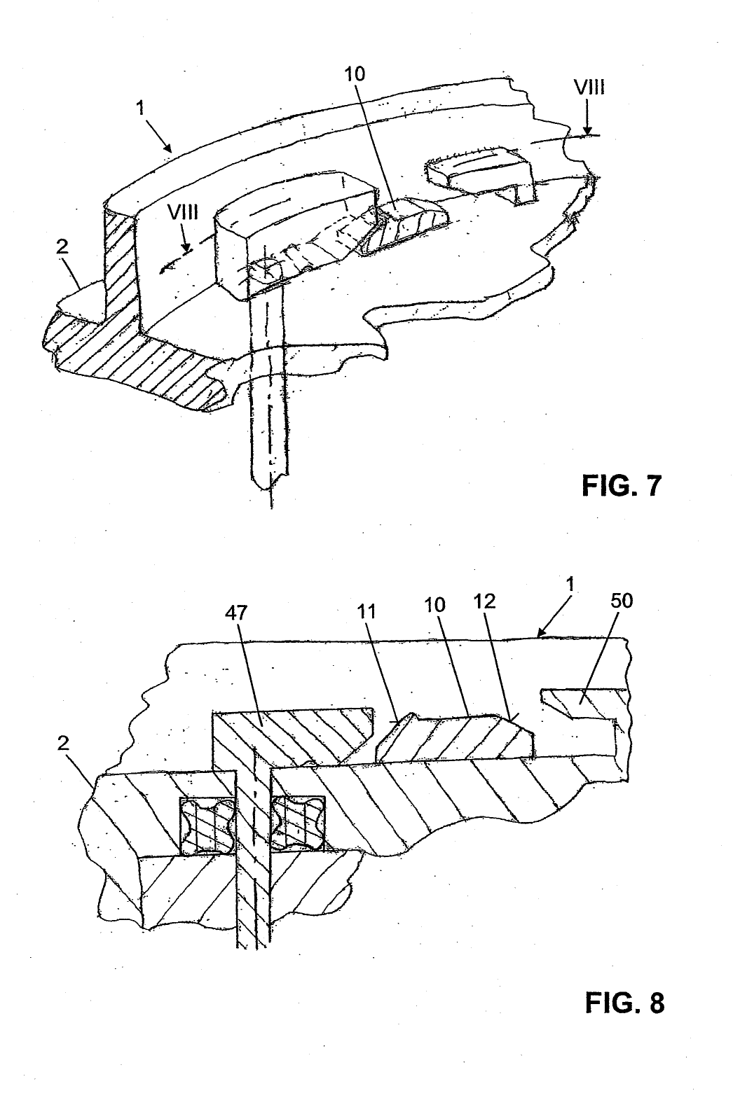

FIG. 7 shows a view according to FIG. 4, wherein the switching member is here, however, in a position which locks the pulsator wheel, and

FIG. 8 shows a section along the line VIII-VIII of FIG. 7.

FIG. 1 shows a section through the shower head 1, which usually has a housing 2. The grip 53 is here broken off from the housing 2, which grip is preferably a handle and in a known manner is hollow and serves to supply water to a water channel 33. In this water channel 33 there is disposed a valve V, which is a switching valve and which can be operated by hand and in particular with the thumb of the hand holding the grip 53. Through actuation of the push button 3, water can selectively be delivered through a perlator 35 or through nozzle apertures 39 arranged coaxially to the perlator 35. In the depressed position of the push button 3 shown in FIG. 3, moreover, a pulsator wheel 38 can be energized or the push button 3 fixed in the depressed position by swiveling of the push button 3 about a longitudinal axis 45. In order that the push button 3 can be swiveled, it possesses on a top side 5 a grip molding 4, which supports the actuating thumb. In the top view of the push button 3 according to FIG. 2, the swivel position with energized pulsator wheel 38 is denoted by C, and the position in which the push button 3 is fixed in the depressed position is denoted by B. The shower head 1 thus allows three operating modes. In the first operating mode, water is delivered through the perlator 35. In the second operating mode, water flows out through the nozzle apertures 39, the pulsator wheel 38 being inactive. In the third operating mode, water likewise flows out through nozzle apertures 39, but in this case the pulsator wheel 38 is energized. This third operating mode is referred to as “pulsator jet operation”.

In the housing 2 there is disposed a valve housing 18, which is sealed with respect to the housing 2 with seals 21 and 31, and 20. In the valve housing 18 are installed an upper insert 23 and a lower insert 29, which form an upper valve seat 24 and a lower valve seat 25. The lower insert 29 is sealed with respect to the upper insert 23 with a sealing element 26.

The valve V has a rod-shaped valve member 14 having a longitudinal axis 45, in which longitudinal axis this valve member 14 is adjustable such that a double valve cone 15 bears selectively against the upper valve seat 24 or against the lower valve seat 25. Above the double valve cone 15, the valve member 14 has a pin 16, which is sealed with respect to the valve housing 18 with a sealing sleeve 22 and which, at an upper end, is fixedly connected to the push button 3. The valve housing 18 is sealed with respect to the housing 2 with a sealing element 19. A further pin 17 of the valve member 14 is located beneath the double valve cone 15 and this is displaceably mounted in the lower insert 29. If the double valve cone 15 according to FIG. 1 bears against the upper valve seat 24, then an upper pass-through opening 55 is closed. A lower pass-through opening 56, on the other hand, is open. In this position of the valve member 14, the water can flow from the water channel 33 through the pass-through opening 56 to the perlator 35 and out through this. If the double valve cone 15 is in the position shown in FIG. 3, then the lower pass-through opening 56 is closed, while the upper pass-through opening 55 is open. In this position, water can flow out of the water channel 33 through the pass-through opening 55 to the nozzle apertures 39 and out through these.

In that position of the double valve cone 15 which is shown in FIG. 1, the push button 3 is raised. This position is determined by the stop of the double valve cone 15 on the upper valve seat 24. The push button 3 is held in the position shown in FIG. 1 with a spring element 13, which is configured, for instance, as a spiral spring. This spring element 13 is supported on one side against the housing 2 and on the other side against a connecting part 8, which is inserted from below into the push button 3. With latching cams 7, which are engaged in recesses 9 of the connecting part 8, the push button 3 is connected to the connecting part 8. The latching cams 7 are formed onto cylindrical lug 6 of the push button 3. If the push button 3 is pressed downward counter to the reactive force of the spring element 13, then the double valve cone 15 is displaced into the position shown in FIG. 3. Given sufficient water pressure, this position is held counter to the force of the spring element 13. If the water pressure falls below a set value, then the valve member 14 is brought by the tension of the spring element 13 into the position shown in FIG. 1.

The pulsator wheel 38 is mounted in an annular space 37, which is formed by a bearing part 36, the lower insert 29 and the upper insert 23. The bearing part 36 also forms with a spray base 34 the pass-through openings 39. The bearing part 36 and the spray base 34 additionally surround the perlator 35. This is sealed with a sealing element 32 with respect to the lower insert 29, which forms an outwardly projecting flange 30. The pulsator wheel 38 is known per se and possesses a plurality of upwardly directed vanes 44, which can be subjected to an oncoming flow through nozzle apertures 49, as shown by FIG. 6. These nozzle apertures 49 are located in the upper insert 23. When the valve member 14 is set in the position shown in FIG. 3, water can thus flow in through the pass-through opening 55 to the nozzle aperture 49 and through this into the annular space 37. The nozzle apertures 49 are located in a lower wall 58, which also contains the bore 41. The pulsator wheel 38 can be locked with a switching member 40, so it does not turn even when bombarded with inflowing water, which water thus flows without interruption continuously out through the nozzle apertures 39. If the pulsator wheel 38 is locked, then it is oriented through engagement of the switching member 40 such that pass-through openings 61 in the pulsator wheel 38 are aligned with the nozzle apertures 39. As described below, the switching member 40 can be actuated such that the pulsator wheel 38 can either rotate freely, and thus a pulsating jet is generated, or is locked.

The switching member 40 possesses a pin 52, which is mounted at a distance from the rotational axis 45 and parallel thereto in a bore of the valve housing 18, as well as in a limitedly displaceable manner in the upper insert 23. With a lower end 40b, the pin 52 engages in a bore 41 of the upper insert 23. Above this lower end 40b, there is mounted on the pin 52 a supporting ring 43, against which a spring element 42, for instance a spiral spring, is supported. This spiral spring 42 is supported on the other side against the valve housing 18. An upper end 40a is located outside or above the housing 2 within a collar 46 formed onto the housing. The pin 52 is sealed with respect to the housing 2 and the valve housing 18 with a sealing element 28. At this upper end 40a, a head 47 is formed onto the pin 52, which head, for instance, according to FIGS. 4 and 5, protrudes laterally and, on the bottom side, possesses a wedge surface 48 and a latching groove 57. At a distance from the head 47, a crosspiece 50 is formed onto the valve housing 2, which crosspiece on the bottom side likewise possesses a wedge surface 51. Between the head 47 and the crosspiece 50 there is arranged a slide 10, which is fixedly connected to the push button 3 and possesses on the top side a latching cam 7, which interacts with the latching groove 57. The slide 10 additionally possesses two opposite wedge surfaces 11 and 12.

In that position of the push button 3 which is shown in FIG. 1, the lower end 40b of the pin 52 engages in the pulsator wheel 38 and locks this. The pulsator wheel 38 cannot therefore turn, since vanes 44 butt against this lower end 40b. For the release of the pulsator wheel 38, the lower end 40b can now be raised into the position shown in FIG. 3, in which the lower end 40b does not project downward out of the bore 41, and thus does not project into the motional path of the pulsator wheel 38. To this end, the push button 3 is forced in the direction of the rotational axis 45 and thus, in the axis of the valve V, downward into the position shown in FIG. 3. The grip molding 4 here remains in the position A shown in FIG. 2. The push button 3 is now swiveled by this grip molding 4 into the position C shown in dashed representation in FIG. 2. As a result of this swivel movement, the slide 10 is slid under the head 47, until finally the latching cam engages detachably in the latching groove 57. As a result of the slide 10, the head 47 and hence the pin 52 are thus raised by the lift H indicated in FIG. 5. The pulsator wheel 38 is thus no longer locked and can be freely rotated by the water pressure onto the vanes 44 and can thus periodically interrupt the water jet. The spring element 42 is here tensioned. The force of the spring element 42 is greater than the force of the spring element 13, so that the switching member 40 holds the push button 4 in the position shown in FIG. 3. Even without water pressure on the double valve cone 15, this position is held.

In order to interrupt the pulsator operation, the push button 3 is swiveled by the grip molding 4 about the rotational axis 45 into the position A shown in FIG. 2. The slide 10 hereupon makes its way into the position shown in FIGS. 7 and 8. The slide 10 is thus located between the head 47 and the crosspiece 50. Since the pin 52 is no longer supported against the head 47, this pin 52 is displaced by the spring element 42 back into the position shown in FIG. 1. The lower end 40b is thus back in the region of the pulsator wheel 38. If the push button 3 is released, then the slide 10 moves upward between the head 47 and the crosspiece 50.

Optionally, the push button 3 can however be swiveled, in the depressed position, into the position B shown in FIG. 2, so that the slide 10 is slid with the wedge surface 60 under the crosspiece 50. The crosspiece 50 prevents the push button 3 from being possibly moved upward by the tension of the spring element 13. In this position B, the double valve cone 15 thus remains in the position shown in FIG. 3, to be precise irrespective of the water pressure. Through swiveling of the push button 3 by the grip molding 4, the pulsator wheel 38 can thus be switched on and off with a simple swivel movement, the swivel angle according to FIG. 2 being relatively small and, in particular, less than 45°. In the intermediate position A, the first operating mode can then again be set, in which water flows out through the perlator 35. The push button 3, which forms the actuating member, is rotatably mounted, but can otherwise also be configured according to choice. Preferably, the push button 3 possesses an outer, preferably substantially cylindrical wall 59, which possesses a shell surface 60 substantially aligned with a shell surface 54 of the housing 2.

### REFERENCE SYMBOL LIST

1 shower head
2 housing
3 push button
4 grip molding
5 top side
6 lug
7 latching cam
8 connecting part
9 recess
10 slide
11 wedge surface
12 wedge surface
13 spring element
14 valve member
15 double valve cone
16 pin
17 pin
18 valve housing
19 sealing element
20 sealing element
21 sealing element
22 sealing sleeve
23 upper insert
24 upper valve seat
25 lower valve seat
26 sealing element
27 bore
28 sealing element
29 lower insert
30 flange
31 sealing element
32 sealing element
33 water channel
34 spray base
35 perlator
36 bearing part
37 annular space
38 pulsator wheel
39 nozzle apertures
40 switching member
40a upper end
40b lower end
41 spring element bore
42 spring element
43 supporting ring
44 vane
45 rotational axis
46 collar
47 head
48 wedge surface
49 nozzle apertures
50 crosspiece
51 wedge surface
52 pin
53 grip
54 shell surface
55 pass-through opening
56 pass-through opening
57 latching groove
58 wall
59 wall
60 shell surface
61 pass-through opening
A swivel position
B swivel position
C swivel position
H lift
V valve

1-17. (canceled)

18. A shower head for selective operation in at least two operating modes, comprising a housing and a
valve disposed therein, said valve having a valve member disposed in a water channel, which valve member is connected to an actuating member and, for opening and closing or switching of the water channel, interacts with at least one valve seat, and comprising a pulsator wheel, which can be connected to the water channel and can be detachably locked with a switching member operatively connected to the actuating member, wherein the actuating member is mounted rotatably
about a longitudinal axis of the valve member and is connected to the switching member such that the latter is adjustable with a rotary movement of the actuating member about the longitudinal axis in order to lock or release the pulsator wheel.

19. The shower head as claimed in claim 18, wherein the locking of the pulsator wheel can be released by displacement of the actuating member along the longitudinal axis of the valve member, as well as by a rotary movement of the actuating member about the same longitudinal axis.

20. The shower head as claimed in claim 18, wherein the rotary movement of the actuating member for locking of the pulsator wheel is opposite to a rotary movement of the actuating member for releasing the locking of the pulsator wheel.

21. The shower head as claimed in claim 18, wherein the rotary movement of the actuating member for locking of the pulsator wheel runs in the counterclockwise direction and the rotary movement for releasing the locking of the pulsator wheel runs in the counterclockwise direction.

22. The shower head as claimed in claim 18, wherein the switching member is arranged at a distance from and substantially parallel to the valve member.

23. The shower head as claimed in claim 18, wherein the switching member has a pin, which in a locking state engages in the pulsator wheel.

24. The shower head as claimed in claim 18, wherein the actuating member is lockable by a rotary movement of the same.

25. The shower head as claimed in claim 18, wherein the actuating member is, in particular, a push button, which is disposed on a side of the shower head which lies opposite an outlet.

26. The shower head as claimed in claim 18, wherein the valve is a switching valve, wherein the valve member, in a basic position, closes off a first passage and, in a operating position, a second passage.

27. The shower head as claimed in claim 26, wherein the first passage is connected to said water channel.

28. The shower head as claimed in claim 18, wherein upon a displacement of the actuating member along the longitudinal axis of the valve member, the valve member is displaced from a basic position into the operating position.

29. The shower head as claimed in claim 18, wherein the valve is a shut-off valve, which in a first position closes off a passage and in a second position opens up said passage.

30. The shower head as claimed in claim 18, wherein in the basic position of the valve member, the pulsator wheel can be driven.

31. The shower head as claimed in claim 18, wherein the actuating member is connected to a slide, which is operatively connected to the switching member.

32. The shower head as claimed in claim 31, wherein said switching member can be displaced and, in particular, raised with the slide in order to release the pulsator wheel.

33. The shower head as claimed in claim 18, wherein the actuating member can be locked by displacement of the actuating member along the longitudinal axis of the valve member, as well as by a rotary movement of the actuating member about this longitudinal axis.

34. The shower head as claimed in claim 26, wherein the second passage, in the operating position, is connected to said water channel.
